(19) United States
(12) Patent Application Publication
(10) Pub. No.: US 2021/0248570 A1
(43) Pub. Date: Aug. 12, 2021

(54) ELECTRONIC MONEY ESCROW SETTLEMENT SYSTEM AND ELECTRONIC MONEY ESCROW SETTLEMENT METHOD

(71) Applicant: JP MEDIA DIRECT CO., LTD., Tokyo (JP)

(72) Inventors: Taku KAGESHIMA, Tokyo (JP); Yoshizane KUMAGAWA, Tokyo (JP)

(21) Appl. No.: 17/054,899

(22) PCT Filed: Jul. 18, 2018
(86) PCT No.: PCT/JP18/26811

§ 371 Date: Nov. 12, 2020

(51) Int. Cl. G06Q 20/02; G06Q 40/02; G06Q 20/40; G06Q 20/04; G06Q 10/08; G06Q 20/38

(52) U.S. Cl. CPC G06Q 20/02; G06Q 40/02; G06Q 20/4037; G06Q 20/381; G06Q 20/407; G06Q 10/0838; G06Q 20/047

(57) ABSTRACT

An electronic money escrow settlement system is provided with an escrow service server for allowing usage of electronic money for escrow settlements. A transaction information acquisition unit receives transaction information from a transaction site server. In response to acknowledgement of completion of a deposit made by a purchaser into a first account for first electronic money of the escrow service server, a payment reception processing unit notifies a seller terminal about completion of the deposit. In response to reception of a commodity reception notification from the purchaser, a payment transfer processing unit remits, from a second account of the escrow service server to the seller, an amount of second electronic money corresponding to the paid amount of the first electronic money deposited by the purchaser into the first account.

### TECHNICAL FIELD

The present disclosure relates to an electronic money escrow settlement system and an electronic money escrow settlement method for enabling escrow settlement using electronic money in a transaction.

### BACKGROUND ART

As communication terminals connected to a network has become widespread, electronic commerce has expanded rapidly. In electronic commerce, part of or all of the transactions are performed on a network. Since all of the transactions on the network are subject to electronic commerce, the area of electronic commerce is tremendously wide. Electronic commerce can include, for example, business-to-business (B-to-B) transaction, business-to-consumer (B-to-C) transaction, and consumer-to-consumer transaction (C-to-C) transaction.

Conventionally, in electronic commerce, trouble tends to occur in payment and delivery of an item. More specifically, for example, buyers have troubles in which their item does not arrive even after they have already transferred money or the order looks different from that in a photo they viewed during the purchase. In contrast, sellers have troubles in which they do not receive the payment even after they have already shipped an item. Patent Document 1 describes an example of a technique of an escrow settlement system that prevents such troubles.

The escrow settlement system described in Patent Document 1 includes a virtual account creating unit that creates a virtual account including electronic information in reference to predetermined information transmitted from the seller and the buyer of an item. The escrow settlement system also includes a collection instruction unit. When receiving deposit information including price information of an order for the virtual account of the buyer of the order, the collection instruction unit transmits an instruction to collect the item for the buyer of the item and transmits an instruction to collect the item for a distributor. The escrow settlement system further includes a virtual account transfer unit. When receiving a report saying an item has been delivered from the distributor to the buyer of the order, the virtual account transfer unit transfers the price information of the item from the virtual account of the buyer of the item to the virtual account of the seller of the item.

### Prior Art Documents

### Patent Document

Patent Document 1: Japanese Laid-Open Patent Publication No. 2002-74219

### SUMMARY OF THE INVENTION

### Problems that the Invention is to Solve

Recently, in electronic commerce, settlement is frequently done using electronic money instead of cash. In electronic commerce using the internet or the like, electronic money can be handled more easily than cash. Thus, the use of electronic money as a settlement means has been widespread.

While currency normally has one type, electronic money has multiple types and, even a little, has a limit to how to use electronic money according to its types. The widespread use of various types of electronic money improves the convenience for electronic money. As the use of electronic money becomes more popular, sellers have to handle settlement using multiple types of electronic money and purchasers have to prepare electronic money usable for settlement. In this manner, sellers and purchasers have difficulty managing electronic money. This will reduce the convenience for electronic money.

It is an objective of the present disclosure to provide an electronic money escrow settlement system and an electronic money escrow settlement method capable of increasing the convenience for electronic money in escrow settlement.

### Means for Solving the Problem

An electronic money escrow settlement system that solves the above-described problem includes an escrow service server enabling use of electronic money for escrow settlement in a transaction. The escrow service server includes a transaction information acquisition unit that receives transaction information from a transaction site server where an item is sold. The escrow service server includes a money receipt processing unit that recognizes completion of deposit from a purchaser designated by the transaction information to a first account and notifies a seller terminal of the completion of the deposit. The first account is used for a first electronic money, a type of the first electronic money is the same as a type designated for payment in the transaction information, and the escrow service server acknowledges a balance on the first account. The escrow service server includes a money transfer processing unit that transfers a second electronic money from a second account to a seller in response to receipt of an item receipt notification from the purchaser. The second account is used for the second electronic money, an amount of the second electronic money corresponds to a payment equivalent from the first electronic money that has been deposited from the purchaser to the first account, a type of the second electronic money is different from the type of the first electronic money and designated for receipt by the seller in the transaction information, and the escrow service server acknowledges a balance on the second account.

An electronic money escrow settlement method that solves the above-described problem is executed in an escrow service server enabling use of electronic money for escrow settlement in a transaction. The electronic money escrow settlement method includes a transaction information acquisition step that receives transaction information from a transaction site server where an item is sold. The electronic money escrow settlement method includes a money receipt processing step that recognizes completion of deposit from a purchaser designated by the transaction information to a first account and notifies a seller terminal of the completion of the deposit. The first account is used for a first electronic money, a type of the first electronic money is the same as a type designated for payment in the transaction information, and the escrow service server acknowledges a balance on the first account. The electronic money escrow settlement method includes a money transfer processing step that transfers a second electronic money from a second account to a seller in response to receipt of an item receipt notification from the purchaser. The second account is used for the second electronic money, an amount of the second electronic money corresponds to a payment equivalent from the first electronic money that has been deposited from the purchaser to the first account, a type of the second electronic money is different from the type of the first electronic money and designated for receipt by the seller in the transaction information, and the escrow service server acknowledges a balance on the second account.

In such a configuration or method, even if different types of electronic money are used for settlement between the seller and the purchaser, escrow settlement can be executed between the different types of electronic money. This increases the convenience for electronic money in escrow settlement.

In a preferred configuration, the transaction information includes purchaser information, seller information, and item information. The money receipt processing unit uses the purchaser information, the seller information, and the item information to notify the purchaser of an amount of the first electronic money that is to be transferred to the first account and to determine whether an amount of the first electronic money that has been deposited to the first account is correct.

In such a configuration, the purchaser terminal is notified of the information that is needed for money transfer. This allows the purchaser to easily pay a correct amount of electronic money. Further, it is determined whether the deposited amount of electronic money is correct. This allows for smooth settlement.

In a preferred configuration, the electronic money escrow settlement system is capable of acquiring shipment information of the item from a delivery management server that manages delivery of the item. When failing to acquire the shipment information of the item from the delivery management server subsequent to an elapse of a predetermined period after notification of the completion of the deposit from the money receipt processing unit to the seller terminal, the money receipt processing unit gives back to the purchaser the first electronic money of which the deposit to the first account was completed under a predetermined money-back condition.

In such a configuration, in a case where the seller does not ship an item even after the purchaser pays the first electronic money, the type of electronic money deposited by the purchaser is given back to the purchaser. This ensures the safety of a transaction.

In a preferred configuration, the electronic money escrow settlement system is capable of acquiring delivery information of the item from a delivery management server that manages delivery of the item. When failing to receive the item receipt notification from the purchaser, the money transfer processing unit transfers to the seller the amount of the second electronic money corresponding to the payment equivalent under a predetermined payment condition subsequent to an elapse of a predetermined period after confirmation of receipt of the item in reference to the delivery information from the delivery management server.

In such a configuration, even if the purchaser forgets to confirm or does not confirm the receipt of an item, the electronic money corresponding to the payment equivalent is paid to the seller. This ensures the safety of a transaction.

In a preferred configuration, the electronic money escrow settlement system includes an account management unit that manages the balance on the first account and the balance on the second account. The account management unit executes a process of at least one of paying out electronic money from the first account or the second account of which the balance exceeds a set upper limit value or adding electronic money to the first account or the second account of which the balance falls below a set lower limit value.

In such a configuration, the balance on the first account and the balance on the second account are maintained between the upper limit value and the lower limit value set through adjustment that is performed by payout or adding. This maintains the amount of money held in the first account and the second account at a correct amount. Further, when the balance on the first account and the balance on the second account reach the set upper limit value or lower limit value, the number of times of payout or adding is reduced by paying out or adding a large amount of money. This also reduces trouble and commission.

In a preferred configuration, the account management unit adds to an other account all of or part of an amount equivalent to the paid-out electronic money, the other account being used for electronic money that differs in type from the paid-out electronic money, a fulfillment rate relative to an upper limit value or a lower limit value set for the other account being low.

In a preferred configuration, the account management unit adds, through transfer from an other account, electronic money that needs the adding, the other account being used for electronic money that differs in type from the electronic money that needs the adding, a fulfillment rate relative to an upper limit value or a lower limit value set for the other account being high.

In such a configuration, in multiple accounts managed by the escrow service server, money is moved from an account with a high balance to an account with a low balance. This reduces deposit and withdrawal that are made externally. Thus, the convenience for money management is high.

### Effects of the Invention

In the present disclosure, the convenience for electronic money in escrow settlement is increased.

### BRIEF DESCRIPTION OF THE DRAWINGS

FIG. 1 is a block diagram showing an electronic money escrow settlement system and an electronic money escrow settlement method according to an embodiment.

FIG. 2 is a block diagram showing the configuration of the present embodiment.

FIG. 3 is a sequence chart showing a procedure in the present embodiment.

FIG. 4 is a sequence chart showing a procedure in the present embodiment.

FIG. 5 is a sequence chart showing a procedure in the present embodiment.

FIG. 6 is a sequence chart showing a procedure in the present embodiment.

### MODES FOR CARRYING OUT THE INVENTION

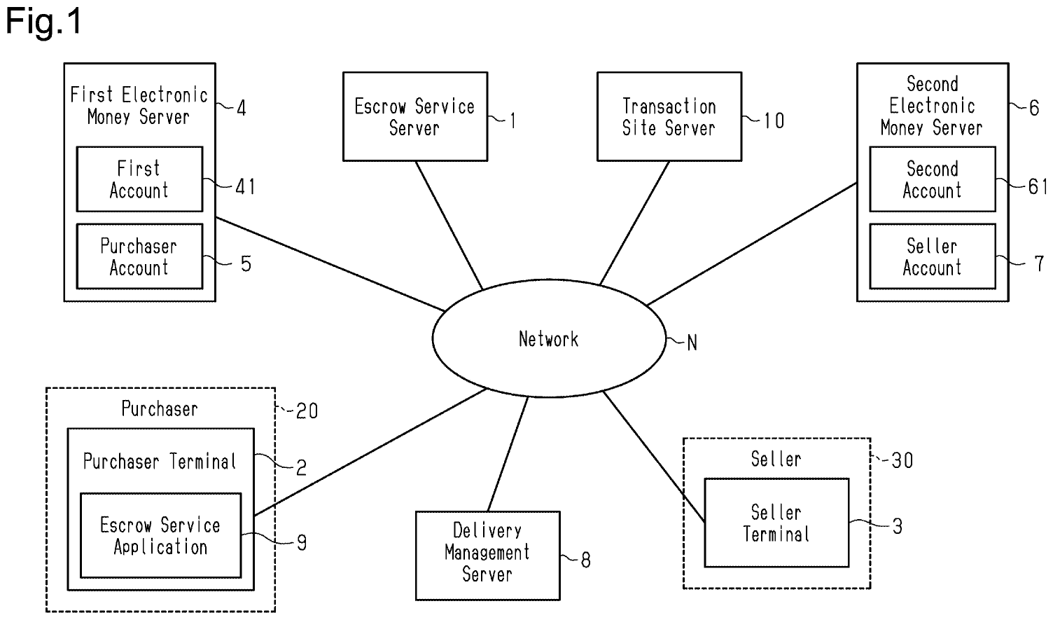

The present embodiment will now be described with reference to FIGS. 1 to 6. In the present embodiment, a description will be made for an electronic money escrow settlement system and an electronic money escrow settlement method for enabling escrow settlement using multiple types of electronic money.

Electronic money represents a monetary value (hereinafter simply referred to as value) represented by digital data. There are multiple types of electronic money. Thus, even a little, how to use electronic money differs according to its types (there is a small limit). For example, one type of electronic money can be used in a predetermined settlement system that is adjusted such that the electronic money can be handled. Thus, usually, one type of electronic money cannot be used in a settlement system adjusted to handle another type of electronic money. Examples of the electronic money service include LINE Pay (registered trademark) and Yahoo! (registered trademark) Money.

Electronic money users can convert currency such as yen or dollars into electronic money and use the converted electronic money to purchase an item or service. In this context, an item may include a tangible article and digital content such as a data file or application program.

The unit of electronic money may be an original unit that differs from the unit of currency and may be the same unit as currency. Further, electronic money may include, for example, virtual currency and corporation currency called corporation point, which is a point program individually issued by a corporation. In addition, electronic money may include a mode in which information is written in an IC card such that electronic money is used like a credit card (IC card type), a mode in which electronic money circulates as data on the internet (network type), and a prepaid card type. The account holding electronic money is normally under management of a group or a corporation that issued the electronic money and may be arranged in an IC card, a server, a mobile terminal or a combination thereof. The account includes electronic information with which a group or a corporation that manages the account stores the amount of electronic money owned by a user. The account stores the amount of electronic money allocated to users such that the amount of electronic money can be increased and decreased.

The connection via a network N in the present embodiment will now be described with reference to FIG. 1. The network N may be a public communication line, a dedicated communication line, or a combination thereof. An escrow service server 1, a purchaser terminal 2 operated by a purchaser 20, a seller terminal 3 operated by a seller 30, a first electronic money server 4 that manages a first electronic money, a second electronic money server 6 that manages a second electronic money, a delivery management server 8, and a transaction site server 10 are connected to the network N such that they can communicate with one another. The types of the first electronic money and the second electronic money are different. Settlement with the first electronic money needs a settlement system corresponding to the first electronic money. Settlement with the second electronic money needs a settlement system corresponding to the second electronic money.

The escrow service server 1, the purchaser terminal 2, the seller terminal 3, the first electronic money server 4, the second electronic money server 6, the delivery management server 8, and the transaction site server 10 may be entirely or partially owned and managed by different groups, corporations, or individuals.

With such a configuration, in the present embodiment, for example, a sales transaction between the purchaser 20 and the seller 30 that has been established in the transaction site server 10 is executed by delivering an article via the escrow service server 1 or transferring money using electronic money.

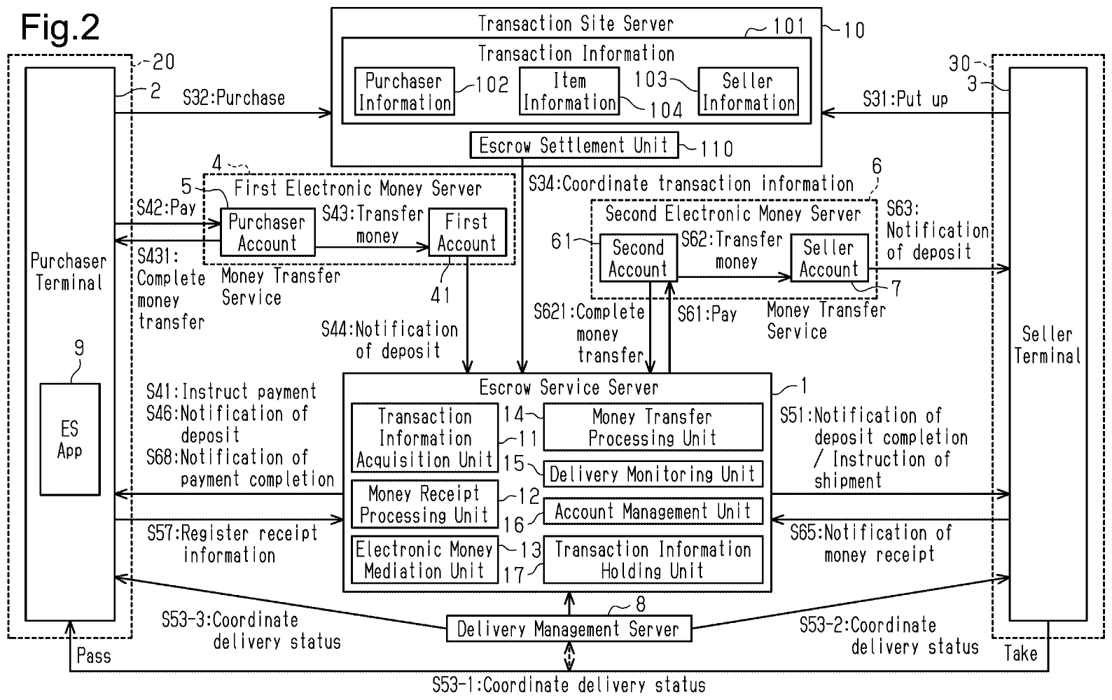

With reference to FIG. 2, the escrow service server 1, the purchaser terminal 2, the seller terminal 3, the first electronic money server 4, the second electronic money server 6, the delivery management server 8, and the transaction site server 10 will now be described.

The transaction site server 10 is a computer such as a personal computer or a workstation that executes, for example, electronic commerce (EC) service such as online shopping service or auction service. It is assumed that the electronic commerce executed in the transaction site server 10 is a general known one. Thus, the electronic commerce will not be described. The transaction site server 10 includes transaction information 101 as the information used for transactions executed in the site. The transaction information 101 includes purchaser information 102, seller information 103, item information 104, and a transaction ID number. The transaction site server 10 includes an escrow settlement unit 110 that executes a process corresponding to the selection of escrow settlement as one of the methods for delivery and settlement. The escrow settlement unit 110 transmits the transaction information 101 to the escrow service server 1 when escrow settlement is selected as the method for delivery and settlement. The transaction site server 10 includes, as the method for delivery and settlement, methods other than escrow settlement. The methods other than escrow settlement may be selected.

The purchaser terminal 2 is a computer, such as a mobile phone, a smartphone, a tablet computer, or a personal computer, operated by the purchaser 20 of an item. The purchaser 20 is able to check and purchase items sold by the seller 30 by operating the purchaser terminal 2 and accessing the transaction site server 10. In addition, the purchaser 20 is able to perform various types of operation related to electronic commerce in the transaction site server 10. Further, the purchaser 20 operates the purchaser terminal 2 to exchange information related to escrow service with the escrow service server 1. Furthermore, the purchaser 20 operates the purchaser terminal 2 to operate a purchaser account 5 allocated to the purchaser 20 and pay the purchase money of an item using the first electronic money, which the purchaser 20 wishes to use in the transaction.

An escrow service application (ESApp) 9 is provided (installed) in the purchaser terminal 2. The ESApp 9 is an application that facilitates transmission and reception of information to and from the escrow service server 1. The ESApp 9 causes the purchaser 20 to input information of which the escrow service server 1 has to be notified or collects the information from the purchaser terminal 2 to generate the information, and then notifies the escrow service server 1 of the information. Further, the ESApp 9 may hold information related to the transaction executed by the purchaser 20 using the purchaser terminal 2.

The seller terminal 3 is a computer, such as a mobile phone, a smartphone, a tablet computer, or a personal computer, operated by the seller 30 of an item. The seller 30 is able to confirm an order from the purchaser 20 by operating the seller terminal 3 and accessing the transaction site server 10. In addition, the seller 30 is able to perform various types of operation related to electronic commerce in the transaction site server 10. Further, the seller 30 operates the seller terminal 3 to exchange information related to escrow service with the escrow service server 1. Furthermore, the seller 30 operates the seller terminal 3 to operate a seller account 7 allocated to the seller 30 and confirm receipt of the purchase money of an item using the second electronic money, which the seller 30 wishes to use in the transaction.

The first electronic money server 4 is a server that manages the circulation of the first electronic money. The first electronic money server 4 maintains and manages an account that can handle the first electronic money server 4 and lends an account to a user. The first electronic money server 4 includes, as a lending account, the purchaser account 5 and a first account 41. Under the name of the purchaser 20, the purchaser 20 manages the income and expenses of electronic money in the purchaser account 5. Under the name of a person who manages the escrow service server 1, the balance on the first account 41 is acknowledged by the escrow service server 1.

The second electronic money server 6 is a server that manages the circulation of the second electronic money, which differs in type from the first electronic money. The second electronic money server 6 maintains and manages an account that can handle the second electronic money and lends an account to a user. The second electronic money server 6 includes, as a lending account, the seller account 7 and a second account 61. Under the name of the seller 30, the seller 30 manages the income and expenses of electronic money in the seller account 7. Under the name of a person who manages the escrow service server 1, the balance on the second account 61 is acknowledged by the escrow service server 1.

The first and second electronic money servers 4 and 6 are computers such as personal computers or workstations that execute electronic money service. The first and second electronic money servers 4 and 6 manage the circulation of different types of electronic money. It is assumed that the first and second electronic money servers 4 and 6 enable a known general electronic money service. That is, although not illustrated in the drawings, the electronic money server includes a transaction information acquisition means for acquiring the transaction information between electronic money users, a settlement means for executing settlement with a financial institution system when purchasing electronic money or changing the electronic money back into cash (cashing), and a transaction executing means for executing various types of transaction or processing for electronic money. The amounts of electronic money linked to the users are stored in accounts. Further, the electronic money server may include a history information searching means for searching the history information of electronic money stored in an electronic money wallet, a history information notifying means for notifying a user of the searched information upon request of the user, and a history information protecting means for semi-permanently protecting history information.

The delivery management server 8 is a computer such as a personal computer or a workstation that executes service related to the delivery of an item. When receiving the transaction information 101 from the escrow service server 1, the delivery management server 8 can be informed of, for example, the purchaser information 102, the seller information 103, and the item information 104 together with the transaction ID number. Using the transaction ID number or the like, the delivery management server 8 associates the shipping state of an item of the seller 30 with shipment information and associates the delivering state of the item to the purchaser 20 with delivery information. As a neutral third party, the delivery management server 8 uses the transaction ID number to transmit, to the escrow service server 1 through the network N, the fact that the seller 30 has shipped an item or the fact that the purchaser 20 has received the item (delivery completion notification).

The escrow service server 1 is a computer such as a personal computer or a workstation that executes the processes related to escrow service. When receiving the transaction information 101 from the transaction site server 10, the escrow service server 1 executes a process related to payment performed by the purchaser 20 and shipment performed by the seller 30 and a process related to receipt of the item by the purchaser 20 and the transfer of money to the seller 30.

The escrow service server 1 includes a transaction information acquisition unit 11 and a money receipt processing unit 12. The transaction information acquisition unit 11 acquires the transaction information 101 from the escrow settlement unit 110 and holds the transaction information 101 in a transaction information holding unit 17. The money receipt processing unit 12 executes a money receipt process with the purchaser terminal 2. The escrow service server 1 also includes an electronic money mediation unit 13 capable of converting the values of the first electronic money and the second electronic money, which are of different types, into each other and converting the first electronic money and the second electronic money into currency. The escrow service server 1 further includes a money transfer processing unit 14 that transfers money from the second account 61 to the seller account 7 when the condition for transferring money is satisfied. Furthermore, the escrow service server 1 includes a delivery monitoring unit 15 and an account management unit 16. The delivery monitoring unit 15 monitors the delivery of an item in reference to the information acquired from the delivery management server 8. The account management unit 16 manages the balance on the first account 41 and the balance on the second account 61.

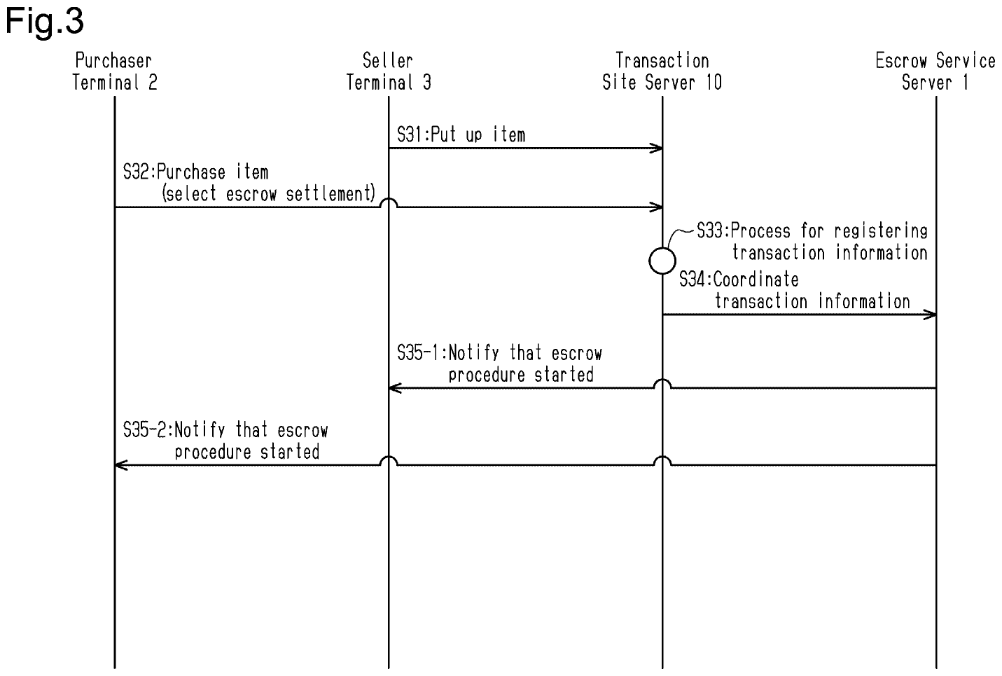

With reference to FIGS. 3 to 6, an example of the transaction using the escrow settlement system of the present embodiment will now be described.

FIG. 3 is a sequence chart showing from when escrow settlement is selected for a transaction established at the transaction site server 10 to when transaction information is coordinated as a first stage of the transaction.

First, the seller 30 operates the seller terminal 3 to put up on the transaction site server 10 an item that the seller 30 is selling (step S31 in FIG. 3). At this time, the seller 30 registers, for the transaction site server 10, the fact that the item can be purchased only through escrow settlement or that escrow settlement can be selected. This allows the purchaser 20 to select escrow settlement to purchase the item put up on the transaction site server 10.

The seller 30 is allowed to put up an item on the transaction site server 10 by registering the seller information 103 in advance. When putting up items, the seller 30 registers the item information 104 for each item that is to be put up. The seller information 103 includes the fact that the type of electronic money the seller uses for settlement is the second electronic money and the fact that the second electronic money server 6 includes the seller account 7. That is, the seller 30 selects the second electronic money for settlement from multiple types of electronic money that can be settled at the escrow service server 1. The seller information 103 includes, for example, the address, name, company name, telephone number, and email address of the seller 30. The item information 104 includes the information of, for example, the type, name, size, and weight of an item. Also, the item information 104 includes, as the information related to purchase, the number of purchases, the purchase price, the delivery fee, and the delivery date.

Next, the purchaser 20 operates the purchaser terminal 2 to purchase an item that is being sold on the transaction site server 10 and selects escrow settlement as a settlement method (step S32 in FIG. 3). This causes the purchaser 20 to determine the purchase of an item put up on the transaction site server 10. In such a state, the purchaser 20 can proceed to the procedure for the purchase.

The purchaser 20 is able to purchase an item on the transaction site server 10 by registering the purchaser information 102. The purchaser information 102 includes the fact that the type of electronic money the purchaser 20 uses for settlement is the first electronic money and the fact that the first electronic money server 4 includes the purchaser account 5. That is, the purchaser 20 selects the first electronic money for settlement from multiple types of electronic money that can be settled at the escrow service server 1. The purchaser information 102 includes, for example, the address, name, company name, telephone number, and email address of the purchaser 20 and the sending address of an item.

After the purchaser terminal 2 is operated so that the purchaser 20 determines to purchase an item, the transaction site server 10 creates the transaction information 101 from the purchaser information 102, the seller information 103, the item information 104, and the transaction ID number. Then, the process of registering the created transaction information 101 on the escrow settlement unit 110 as transaction information is executed (step S33 in FIG. 3). The escrow settlement unit 110 coordinates with the transaction information 101 by notifying the escrow service server 1 of the registered transaction information 101 (step S34 in FIG. 3). Then, the escrow service server 1 acquires, at the transaction information acquisition unit 11, the notified transaction information 101, and starts escrow service using the acquired transaction information 101 (transaction information acquisition step). Further, the escrow service server 1 acquires, at the transaction information acquisition unit 11, the notified transaction information 101, and holds the transaction information 101 in the transaction information holding unit 17 at least until completion of the transaction executed by the escrow service.

To start the escrow service, the escrow service server 1 may notify the seller terminal 3 that the escrow procedure has started (step S35-1 in FIG. 3) or may notify the purchaser terminal 2 that the escrow procedure has started (step S35-2 in FIG. 3). For the notification of the purchaser terminal 2 or the seller terminal 3 from the escrow service server 1, a usable method is selected. The usable method includes, for example, electronic mail, a notification function of the transaction site server 10, and a notification function of the first electronic money server 4 or the second electronic money server 6.

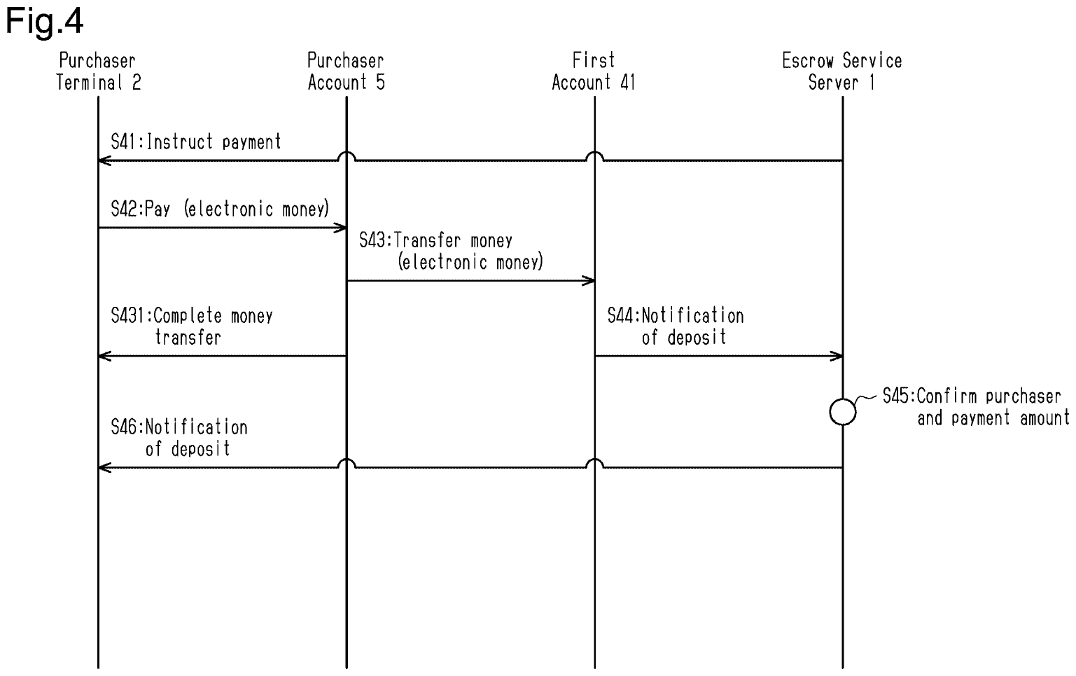

FIG. 4 is a sequence chart showing the payment of the purchase money of an item using electronic money by the purchaser 20 (money receipt processing step) as a second stage of the transaction.

First, when the escrow procedure is started, the escrow service server 1 notifies the purchaser terminal 2 of a payment instruction via electronic mail or the like (step S41 in FIG. 4). The payment instruction includes the number of the first account 41 to which money is transferred and the amount of electronic money which is sent to the first account 41.

When the purchaser terminal 2 is notified of a payment instruction, the purchaser 20 operates the purchaser terminal 2 to execute a payment operation of electronic money from the purchaser account 5 to the first account 41 (step S42 in FIG. 4). This causes the first electronic money to be transferred from the purchaser account 5 to the first account 41 (step S43 in FIG. 4). At this time, the purchaser account 5 and the first account 41 are the same type of account for the first electronic money. Thus, the cost or commission for the first electronic money from the purchaser account 5 to the first account 41 is normally free or relatively low. This is to facilitate the use of the first electronic money. Further, the function corresponding to the purchaser account 5 of the first electronic money server 4 notifies the purchaser terminal 2 of a money transfer completion notification indicating that the transfer of electronic money from the purchaser account 5 to the first account 41 is completed (step S431). This allows the purchaser 20 to confirm that the transfer of money is completed.

When electronic money is deposited to the first account 41, a deposit notification including the information related to the deposit is sent from the first account 41 to the escrow service server 1 (step S44 in FIG. 4). More specifically, the deposit notification is a notification about the information of deposit from the first electronic money server 4 to the first account 41 of the escrow service server 1. The deposit notification may include the information of the purchaser 20 and the information of the payment amount and also include the transaction ID number. The escrow service server 1 verifies the transaction information 101 with the deposit information to confirm the purchaser 20 and confirm the payment amount (step S45 in FIG. 4). At this time, if the transaction ID number is included, the transaction ID number may be used to verify the transaction information 101 with the deposit information.

When confirming through the verification that the transaction information 101 matches the deposit information about the purchaser 20 and the payment amount, the escrow service server 1 notifies the purchaser terminal 2 via electronic mail or the like that the money for the transaction has been deposited (step S46 in FIG. 4). This notification may include, for example, the deposited amount of the first electronic money or where money has been transferred to. This allows the purchaser 20 to confirm through operation of the purchaser terminal 2 that the payment has been made.

When the escrow service server 1 confirms through the verification that the transaction information 101 does not match the deposit information about at least one of the purchaser 20 and the payment amount, only if the procedure content such as the deposit amount includes an error, the first electronic money server 4 used by the purchaser 20 may issue a notification that urges the purchaser terminal 2 to execute the procedure to correct the transfer amount and retransfer money. In addition, for example, when the correction of the transfer amount and the retransfer of money that correspond to the procedure notified for the purchaser terminal 2 are not performed or when money cannot be retransferred, notification about the cancellation of the transaction may be issued.

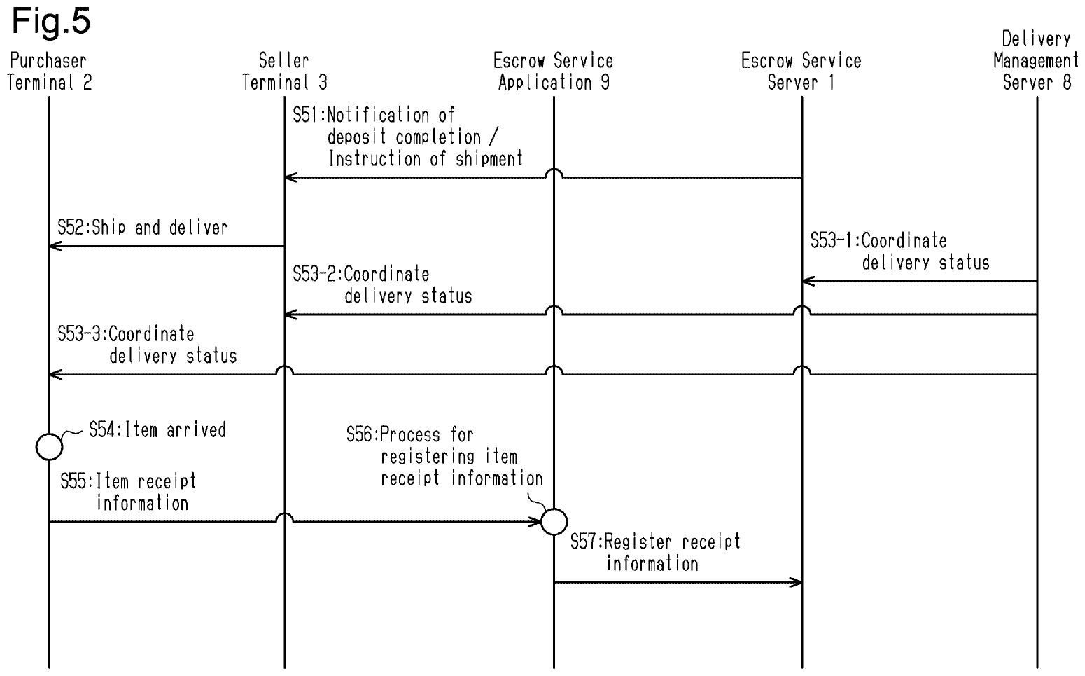

FIG. 5 shows a sequence chart from when the seller 30 ships an item to the purchaser 20 to when the purchaser 20 registers receipt of the item as a third stage of the transaction.

When confirming that the purchaser 20 has made payment, the escrow service server 1 notifies the seller terminal 3, via electronic mail or the like, of a deposit completion notification indicating the deposit has been paid from the purchaser 20 and a shipment instruction for instructing the shipment of the item (step S51 in FIG. 5).

When notified of the shipment instruction, the seller 30 ships the item to the purchaser 20 (step S52 in FIG. 5). Further, the delivery management server 8 acknowledges and manages the delivery status of the item in a period from when a deliverer collects the item from the seller 30 to when the deliverer delivers the item to the purchaser 20. The delivery status includes, for example, taking information in which an item has been taken and passing information in which an item has been passed. The delivery management server 8 establishes a relationship capable of notifying the escrow service server 1, the seller terminal 3, and the purchaser terminal 2 of the delivery status of the item, that is, execute a delivery status coordination (step S53-1, step S53-2, and step S53-3 in FIG. 5). The delivery status coordination allows, for example, the taking information or the passing information between the deliverer and the seller 30 or the purchaser 20 to be coordinated and shared between the delivery management server 8, the escrow service server 1, the seller terminal 3, and the purchaser terminal 2.

When the deliverer passes the item, the item arrives at the purchaser 20. When notified from the delivery management server 8, the purchaser terminal 2 executes a process for the arrival of the item (step S54 in FIG. 5). The process for the item arrival is registration of item receipt completion, more specifically, a process including notification of the status confirmation and receipt confirmation of the arrived item. In the purchaser terminal 2, when the purchaser 20 confirms receipt of the item, the ESApp 9 is operated to register the item receipt (step S55 in FIG. 5) and a registration process for the item receipt information is executed for the ESApp 9 (step S56 in FIG. 5). The ESApp 9 notifies the escrow service server 1 of the registered item receipt information as receipt information and makes registration of the notified receipt information (step S57 in FIG. 5).

When a predetermined period such as a couple of days or a week has passed since the escrow service server 1 issued a notification indicating that deposit from the money receipt processing unit 12 to the seller terminal 3 has been completed or a notification of shipment and the shipment information of the item cannot be gained from the delivery management server 8, the escrow service server 1 may give the first electronic money back to the purchaser 20 under a predetermined money-back condition. The value of electronic money given back may be the same amount or value of the first electronic money of which the deposit to the first account 41 has been completed. Alternatively, the value of electronic money given back may be a value in which a predetermined commission or the like is subtracted from the deposit amount or the like. As another option, the value of electronic money given back may be obtained by being converted into the current value. The predetermined period may be a period such as a couple of days from a week or a period until the on-sale date or shipment date of an item. In addition, the predetermined period may be procrastinated by the seller 30, including a limit to the number of times the predetermined period is changed or the extension period. The predetermined money-back condition may include necessary information from, for example, the number of times shipment from the escrow service server 1 is urged, the result of checking a status by the transaction site server 10, and the approval of the purchaser 20.

In a case where the seller 30 ships an item and then the item receipt notification cannot be received from the purchaser terminal 2, after the predetermined period has passed since confirmation of the receipt of the item in reference to the passing information included in the delivery information from the delivery management server 8, the money transfer processing unit 14 may transfer to the seller 30 the amount of the second electronic money corresponding to a payment equivalent under a predetermined payment condition. The predetermined period may be a period required for checking the state of an item, for example, a couple of days or a longer period such as one to two weeks as a monitoring period. The predetermined payment condition may include necessary information from, for example, the number of times receipt confirmation from the escrow service server 1 is urged, the result of checking a status by the transaction site server 10, and the approval of claim from the seller 30 or compulsory payment.

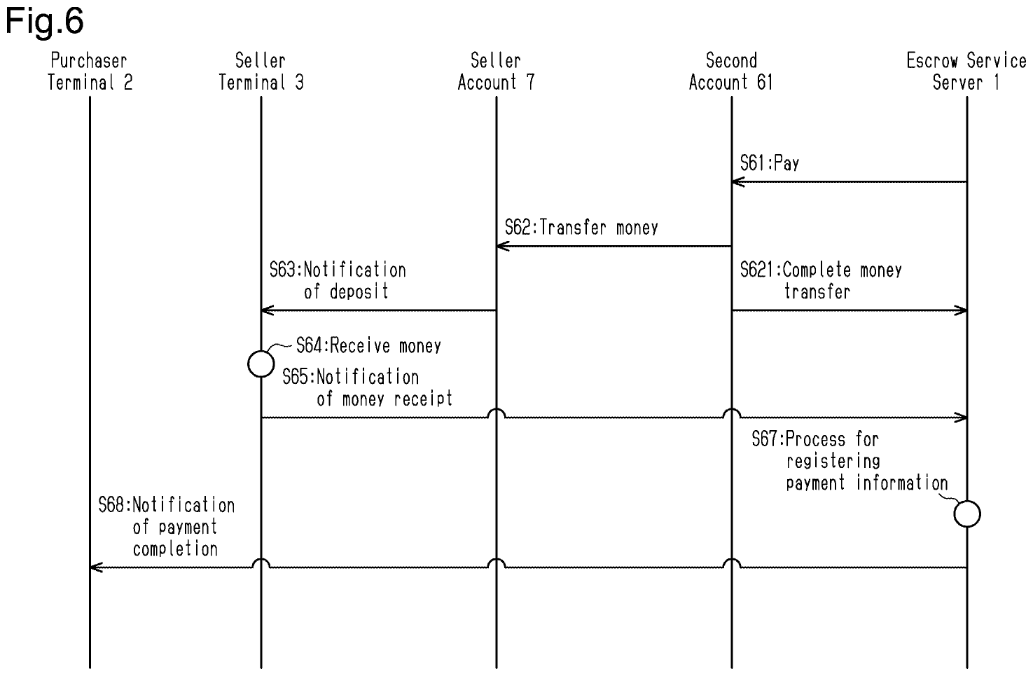

FIG. 6 is a sequence chart showing from when the seller 30 receives money in a certain electronic money service to when the transaction procedure is completed (money transfer processing step) as a fourth stage of the transaction.

Upon registration of the receipt information corresponding to the receipt of an item receipt notification from the purchaser 20, the escrow service server 1 instructs to pay, to the seller 30 in the second electronic money, the purchase amount of an item in the first electronic money that has been temporarily safe kept (commissioned) from the purchaser 20 (step S61 in FIG. 6). At this time, the escrow service server 1 calculates the amount of the second electronic money corresponding to the payment equivalent at the money transfer processing unit 14. The payment equivalent may be the selling price of an item, an amount obtained by subtracting the charge of the escrow service from the selling price of the item, or an amount obtained by deducting a tax or advance money. At the time of deposit, the amount of the first electronic money corresponding to the selling price of an item has already been paid. Thus, the calculated amount of the second electronic money can be spent from the first electronic money that has been deposited from the purchaser 20 to the first account 41.

In response to the payment instruction, the money transfer processing unit 14 transfers the amount of the second electronic money corresponding to the payment equivalent from the second account 61 to the seller account 7 of the seller 30 (step S62 in FIG. 6). When electronic money is deposited to the seller account 7, the deposit notification including the information related to the deposit is sent from the seller account 7 to the seller terminal 3 (step S63 in FIG. 6). In detail, in the deposit notification, the information related to the seller account 7 is sent from the second electronic money server 6 to the seller account 7. Further, the money transfer processing unit 14 (escrow service server 1) receives a money transfer completion notification, which indicates that the transfer of electronic money from the second account 61 to the seller account 7 is completed, from the function corresponding to the second account 61 of the second electronic money server 6 (step S621). This allows the escrow service server 1 to confirm that the transfer of electronic money is completed.

The seller terminal 3 executes the money receipt process for an item in reference to the deposit notification (step S64 in FIG. 6). The money receipt process is to, for example, verify the selling price with the deposit amount. After completing the money receipt process, the seller terminal 3 notifies the escrow service server 1 of money receipt information (step S65 in FIG. 6).

The escrow service server 1 executes a process for registering payment information in reference to, for example, the money transfer completion notification from the second electronic money server 6 or the registration notification of the money receipt information from the seller terminal 3 (step S67 in FIG. 6). In the process for registering payment information, the escrow service server 1 registers the completion of a transaction of the transaction information 101 held by the transaction information holding unit 17 and then completes the process related to the transaction. Further, the escrow service server 1 notifies the purchaser 20 of a payment completion notification via electronic mail or the like (step S68 in FIG. 6). The payment completion notification may include, for example, the completion of money receipt by the seller 30 or the completion of the procedure related to the selling.

### Account Balance Management Process

In the present embodiment, the escrow service server 1 includes the above-described account management unit 16.

The account management unit 16 acknowledges, manages, and adjusts the balance on the first account 41 and the balance on the second account 61. For example, in the account management unit 16, the first account 41 includes an upper limit value and a lower limit value of the balance of electronic money corresponding to the first account 41, and the second account 61 includes an upper limit value and a lower limit value of the balance of electronic money corresponding to the second account 61. The electronic money in the first account 41 and the electronic money in the second account 61 may differ in demand because of, for example, the difference in the amount of circulation. Thus, it is preferred that the upper limit value and the lower limit value be set in correspondence with the demand.

The account management unit 16 makes adjustment such that the balance of electronic money on the first account 41 is between the set upper limit value and the set lower limit value. For example, the account management unit 16 executes a process of at least one of paying out electronic money from the account when the balance on the first account 41 exceeds the set upper limit value and adding electronic money to the account when the balance on the second account 61 falls below the set lower limit value. Further, in the same manner as the adjustment for the balance of electronic money on the first account 41, the account management unit 16 adjusts the balance of electronic money on the second account 61.

When the balance on an account reaches its upper limit value or lower limit value, a larger amount of money than the amount settled in an individual transaction is paid out or added, thereby decreasing the number of conversion or purchase of electronic money. This limits trouble occurring in the conversion or purchase of electronic money and reduces the spending of a commission paid for a financial institution or an electronic money management group during the conversion or purchase.

In the escrow service server 1, when a transaction ends, the total of the balance (value) on the first account 41 and the balance (value) on the second account 61 becomes equal to the total prior to the transaction. That is, in the escrow service server 1, the total balance on the accounts remains unchanged. Further, when a person owns three or more electronic money accounts, the ratio of the balance on each account sometimes varies from the initial ratio and the total balance (total value) on all the accounts remains unchanged. This allows the balances on the accounts to be adjusted between the accounts. If the types of electronic money that can be handled by three or more accounts are different, the number of combinations of the types of electronic money that can be mediated by the escrow service server 1 increases.

For example, when making adjustment to limit an increase in the balance on an account through payout, the value equivalent to the amount of electronic money paid out is entirely or partially added to the account of another type of electronic money that differs from the electronic money paid out. When the number of other electronic money accounts subject to adding is plural, an account having a low fulfillment rate relative to the upper limit value or the lower limit value set to the account is selected to add money to the selected account. This reduces the risk of the balance on an amount becoming excessive.

Further, for example, when making an adjustment to limit a decrease in the balance of an account by adding money, the account management unit 16 pays out and adds electronic money that needs adding from another account for electronic money that differs in type from the electronic money that needs adding. In addition, when there is a number of accounts for another electronic money subject to payout, one of the accounts having a high fulfillment rate relative to an upper limit value or a lower limit value set for the accounts is selected to transfer the electronic money paid out from the account, so that money is added to accounts subject to adding. This reduces the risk of the balance on an account becoming insufficient.

The present embodiment has the following advantages.

(1) Even if different types of electronic money are used for settlement between the seller 30 and the purchaser 20, escrow settlement can be executed between the different types of electronic money. This increases the convenience for electronic money in escrow settlement.

(2) The purchaser terminal 2 is notified of the information that is needed for money transfer. This allows the purchaser 20 to easily pay a correct amount of electronic money. Further, it is determined whether the deposited amount of electronic money is correct. This allows for smooth settlement.

(3) In a case where the seller 30 does not ship an item even after the purchaser 20 pays the first electronic money, the type of electronic money deposited by the purchaser 20 is given back to the purchaser. This ensures the safety of a transaction.

(4) Even if the purchaser 20 forgets to confirm or does not confirm the receipt of an item, the electronic money corresponding to the payment equivalent is paid to the seller 30. This ensures the safety of a transaction.

(5) The balance on the first account 41 and the balance on the second account 61 are maintained between the upper limit value and the lower limit value set through adjustment that is performed by payout or adding. This maintains the amount of money held in the first account 41 and the second account 61 at a correct amount. Further, when the balance on the first account 41 and the balance on the second account 61 reach the set upper limit value or lower limit value, the number of times of payout or adding is reduced by paying out or adding a large amount of money. This also reduces trouble and commission.

(6) In multiple accounts managed by the escrow service server 1, money is moved from an account with a high balance to an account with a low balance. This reduces deposit and withdrawal that are made externally. Thus, the convenience for money management is high.

The above-described embodiment may be modified as follows. The present embodiment and the following modifications can be combined as long as the combined modifications remain technically consistent with each other.

In the above-described embodiment, the purchaser 20 operates the ESApp 9 to register the receipt of an item. Instead, the item receipt information may be registered by the purchaser filling in an entry form (interface) displayed on, for example, a browser.

The escrow service server 1 may instruct payment notified to the purchaser terminal 2 via the ESApp 9 instead of electronic mail or the like. At this time, the amount to be paid (the amount of electronic money) may be set by the purchaser. Alternatively, the amount included in the payment instruction may be set. The setting of the amount restricts situations in which the difference between the selling price and the deposit amount is produced by erroneously setting the deposit amount.

The escrow service server 1 may issue a deposit completion notification or a shipment instruction notification for the seller terminal 3 via the ESApp 9 instead of electronic mail or the like.

The escrow service server 1 may execute a payment completion notification for the purchaser 20 via the ESApp 9 instead of electronic mail or the like.

The escrow service server 1 does not have to include the account management unit 16.

Even if the balance on an account has not reached its upper limit value or lower limit value, a larger amount of money than the amount of money settled in an individual transaction may be paid out or added if necessary. This reduces the number of times of conversion or purchase of electronic money and limits trouble occurring in the conversion or purchase of electronic money, thereby reducing the spending of a commission paid for a financial institution or an electronic money management group during the conversion or purchase.

In the above-described embodiment, in the escrow service server 1, two types of electronic money (i.e., first electronic money and second electronic money) can be used for payment and receipt. Instead, in the escrow service server, the number of accounts of which the accounts are acknowledgeable may be increased so that the number of types of electronic money usable for payment and receipt increases. This increases the convenience for electronic money.

In addition to multiple types of electronic money, the escrow service server may be able to select at least one of one or more currencies, one or more credit cards, one or more debit cards, and one or more prepaid cards may be selectable for settlement.

### DESCRIPTION OF THE REFERENCE NUMERALS

1) Escrow Service Server; 2) Purchaser Terminal; 3) Seller Terminal; 4) First Electronic Money Server; 5) Purchaser Account; 6) Second Electronic Money Server; 7) Seller Account; 8) Delivery Management Server; 9) Escrow Service Application (ESApp); 10) Transaction Site Server; 11) Transaction Information Acquisition Unit; 12) Money Receipt Processing Unit; 13) Electronic Money Mediation Unit; 14) Money Transfer Processing Unit; 15) Delivery Monitoring Unit; 16) Account Management Unit; 17) Transaction Information Holding Unit; 20) Purchaser; 30) Seller; 41) First Account; 61) Second Account; 101) Transaction Information; 102) Purchaser Information; 103) Seller Information; 104) Item Information; 110) Escrow Settlement Unit; N) Network

1. An electronic money escrow settlement system comprising an escrow service server enabling use of electronic money for escrow settlement in a transaction, wherein
the escrow service server includes
a transaction information acquisition unit that receives transaction information from a transaction site server where an item is sold,
a money receipt processing unit that recognizes, when notified of the transaction information by the escrow service server, completion of deposit from an account of a purchaser designated by the transaction information to a first account under a payment instruction by the purchaser who has deposited to the first account and notifies a seller terminal of the completion of the deposit, wherein a type of the first electronic money is the same as a type designated for payment in the transaction information, the escrow service server acknowledges a balance on the first account, and a first electronic money server that manages circulation of the first electronic money lends the first account, and
a money transfer processing unit that transfers a second electronic money from a second account for the second electronic money to an account of a seller and notifies the seller that the transfer is completed in response to receipt of an item receipt notification from the purchaser and in response to a payment instruction by the escrow service server, wherein an amount of the second electronic money corresponds to a payment equivalent from the first electronic money that has been deposited from the purchaser to the first account, a type of the second electronic money is different from the type of the first electronic money and designated for receipt by the seller in the transaction information, the escrow service server acknowledges a balance on the second account, and a second electronic money server that manages circulation of the second electronic money lends the second account.

2. The electronic money escrow settlement system according to claim 1, wherein
the transaction information includes purchaser information, seller information, and item information, and
the money receipt processing unit uses the purchaser information, the seller information, and the item information to notify the purchaser of an amount of the first electronic money that is to be transferred to the first account and to determine whether an amount of the first electronic money that has been deposited to the first account is correct.

3. The electronic money escrow settlement system according to claim 1, wherein
the electronic money escrow settlement system is capable of acquiring shipment information of the item from a delivery management server that manages delivery of the item, and
when failing to acquire the shipment information of the item from the delivery management server subsequent to an elapse of a predetermined period after notification of the completion of the deposit from the money receipt processing unit to the seller terminal, the money receipt processing unit gives back to the account of the purchaser the first electronic money of which the deposit to the first account was completed under a predetermined money-back condition.

4. The electronic money escrow settlement system according to claim 1, wherein
the electronic money escrow settlement system is capable of acquiring delivery information of the item from a delivery management server that manages delivery of the item, and
when failing to receive the item receipt notification from the purchaser, the money transfer processing unit transfers to the account of the seller the amount of the second electronic money corresponding to the payment equivalent under a predetermined payment condition subsequent to an elapse of a predetermined period after confirmation of receipt of the item in reference to the delivery information from the delivery management server.

5. The electronic money escrow settlement system according to claim 1, comprising an account management unit that manages the balance on the first account and the balance on the second account, wherein
the account management unit executes a process of at least one of paying out electronic money from the first account or the second account of which the balance exceeds a set upper limit value or adding electronic money to the first account or the second account of which the balance falls below a set lower limit value.

6. The electronic money escrow settlement system according to claim 5, wherein the account management unit adds to an other account all of or part of an amount equivalent to the paid-out electronic money, the other account being used for electronic money that differs in type from the paid-out electronic money, a fulfillment rate relative to an upper limit value or a lower limit value set for the other account being low.

7. The electronic money escrow settlement system according to claim 5, wherein the account management unit adds, through transfer from an other account, electronic money that needs the adding, the other account being used for electronic money that differs in type from the electronic money that needs the adding, a fulfillment rate relative to an upper limit value or a lower limit value set for the other account being high.

8. An electronic money escrow settlement method executed in an escrow service server enabling use of electronic money for escrow settlement in a transaction, the electronic money escrow settlement method comprising:
receiving transaction information from a transaction site server where an item is sold;
recognizing, when notified of the transaction information by the escrow service server, completion of deposit from an amount of a purchaser designated by the transaction information to a first account under a payment instruction by the purchaser who has deposited to the first account and notifies a seller terminal of the completion of the deposit, wherein a type of the first electronic money is the same as a type designated for payment in the transaction information, the escrow service server acknowledges a balance on the first account, and a first electronic money server that manages circulation of the first electronic money lends the first account; and
transferring a second electronic money from a second account for the second electronic money to an account of a seller and notifies the seller that the transfer is completed in response to receipt of an item receipt notification from the purchaser and in response to a payment instruction by the escrow service server, wherein an amount of the second electronic money corresponds to a payment equivalent from the first electronic money that has been deposited from the purchaser to the first account, a type of the second electronic money is different from the type of the first electronic money and designated for receipt by the seller in the transaction information, the escrow service server acknowledges a balance on the second account, and a second electronic money server that manages circulation of the second electronic money lends the second account.
